(19) United States
(12) Patent Application Publication
(10) Pub. No.: US 2006/0108931 A1
(43) Pub. Date: May 25, 2006

(54) Electromagnetic accelerator having nozzle part

(75) Inventors: Won-taek Park, Seoul (KR); Jin-woo Yoo, Suwon-si (KR); Vladimir Volynets, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/281,356

(22) Filed: Nov. 18, 2005

(30) Foreign Application Priority Data
Nov. 24, 2004 (KR) 10-2004-0097143
Jun. 17, 2005 (KR) 10-2005-0052601

(51) Int. Cl. H01J 19/80

(52) U.S. Cl. 315/39

(57) ABSTRACT

An electromagnetic accelerator having a nozzle part. The electromagnetic accelerator includes an initial discharge part for generating a plasma, an acceleration part and a nozzle part for accelerating the plasma. A composite wave, which is synthesized from a plasma generation frequency and a plasma acceleration frequency, is applied as a current to the electromagnetic accelerator. Accordingly, the uniformity among the plasma generation, the plasma acceleration, and the plasma flow can be ensured, and the plasma generation efficiency and the plasma acceleration efficiency can be maximized.

### CROSS-REFERENCE TO RELATED APPLICATIONS

This application claims priority from Korean Patent Application No. 10-2004-0097143 filed on Nov. 24, 2004, and from Korean Patent Application No. 10-2005-0052601 filed on Jun. 17, 2005, in the Korean Intellectual Property Office, the entire disclosures of which are incorporated herein by reference.

### BACKGROUND OF THE INVENTION

1. Field of the Invention

Apparatuses and methods consistent with the present invention relate generally to an electromagnetic accelerator having a nozzle part, and more particularly, to an electromagnetic accelerator having an initial discharge part for generating a plasma, and an acceleration part and a nozzle part for accelerating the plasma, the electromagnetic accelerator to facilitate the plasma generation and maximize the plasma acceleration efficiency by applying a composite wave of a plasma generation frequency and an acceleration frequency as a current.

2. Description of the Related Art

An electromagnetic accelerator accelerates the flow of the plasma, which is generated or present in a certain space, by use of an electric field energy and a magnetic energy.

The plasma accelerator has been developed as a thruster for a rocket engine for distance space flights, and is now utilized for etching of a wafer in the semiconductor fabrication.

FIG. 1 illustrates a perspective view of a conventional electromagnetic accelerator which is cut through its diameter.

The conventional electromagnetic accelerator as shown in FIG. 1 is constructed according to the phase matching method and is called a traveling wave plasma engine. Reference is made by L. Heflinger entitled “Transverse Traveling Wave Plasma Engine” AIAA vol. 3, p 1029, 1965.

Referring to FIG. 1, as for the electromagnetic accelerator, an external coil 10, an internal coil 20, and a discharge coil 30 wind a channel 70 which is formed by an external cylinder 40 and an internal cylinder 50.

The external and internal coils 10 and 20 are coaxially aligned side by side, and each includes three coils winding the channel 70. The external coil 10 includes a first coil 1, a second coil 2, and a third coil 3 placed in order from a closed end of the channel 70.

Each coil applies the electric current in a radial direction around the channel 70. The external and internal coils 10 and 20 apply the current in the same clockwise or counterclockwise direction so as to reduce the axial magnetic field generated in the channel 70 and reinforce the magnetic field in a direction traversing the channel 70.

The magnetic fields in the channel 70 generated by the discharge coil 30, the external coil 10, and the internal coil 20 induce a secondary electric current according to Maxwell's equations.

A plasma acceleration method of the conventional electromagnetic accelerator applies the current to the coils winding in the direction from the closed end to an open end of the channel 70, as indicated by the arrow, in sequence rather than at the same time. Specifically, when the current flows through the first coil 1, the current is not applied to the second and third coils 2 and 3. When the current flows through the second coil 2, the current is not applied to the first and third coils 1 and 3. The phase of the current passing through the respective coils is regulated to produce the gradient of the magnetic fields in the channel 70 in sequence as shown in FIG. 2. Therefore, the plasma is accelerated to high energy by the magnetic fields.

FIG. 2 shows the intensity of the magnetic fields in the channel 70 of the electromagnetic accelerator of FIG. 1.

As to the graph of FIG. 2, the horizontal axis indicates an axial distance from the closed end to the open end of the channel 70, and the vertical axis indicates the intensity of the magnetic fields traversing the channel 70 in sequence.

A circle represents the secondary current generated in the channel 70 to illustrate that the magnetic field created in the channel 70 accelerates the secondary current and the plasma.

In the graph of FIG. 2, the magnetic field a by the first coil 1 is initially generated at the closed end of the channel 70, and the magnetic fields b and c by the second and third coils 2 and 3 are generated in sequence. Thus, the secondary current d in the channel 70 is accelerated toward the open end and the plasma is also accelerated thereto.

Since the conventional electromagnetic accelerator according to the phase matching method drives the coils by applying the current with only one frequency, it is hard to expect the maximum efficiency in the generation and the acceleration of the plasma. This is because appropriate frequencies are not utilized respectively for the generation and the acceleration of the plasma.

If an initial velocity of the plasma at the closed end is low, the phase difference is so great that the phase matching is inapplicable. If the frequency of the driving current is lowered for the sake of the initial velocity, the energy transfer from the discharge coil 30 to the plasma is hindered and the efficiency of the plasma generation depreciates. In other words, a high frequency is required for the plasma generation and a low frequency is required for the plasma acceleration. Therefore, an electromagnetic acceleration is demanded in consideration of both the plasma generation and the acceleration efficiency.

### SUMMARY OF THE INVENTION

The present invention has been provided to solve the above-mentioned and other problems and disadvantages occurring in the conventional arrangement, and an aspect of the present invention provides an electromagnetic accelerator that includes an initial discharge part for generating a plasma, and an acceleration part and a nozzle part for accelerating the generated plasma so as to provide uniformity among the plasma generation, the plasma acceleration, and the plasma flow. The electromagnetic accelerator can facilely maximize the plasma generation efficiency and the plasma acceleration efficiency by applying a composite wave, which is synthesized from a plasma generation frequency and a plasma acceleration frequency, as a current.

To achieve the above aspect of the present invention, an electromagnetic accelerator includes external and internal cylinders located on a same axis with different diameters from each other; an initial discharge part for generating a plasma in a channel that is defined between the external and internal cylinders by creating a magnetic field in a direction orthogonal to the axial direction; an acceleration part disposed on the external and internal cylinders for accelerating the plasma in the axial direction; and a nozzle part for compressing the plasma from the acceleration part and uniformly emitting the compressed plasma by creating a magnetic field in the axial direction.

The initial discharge part may include a connection part connecting the external and internal cylinders at an opposite side to the plasma acceleration and closing one end of the channel; a discharge coil wound such that a diameter of the discharge coil decreases along an upper surface of the connection part; and at least one first external and internal coils for creating magnetic fields by winding along an inner wall of the internal cylinder and an outer wall of the external cylinder in parallel.

The acceleration part may include at least one second external and internal coils that accelerate the plasma in the axial direction by winding along the inner wall of the internal cylinder and the outer wall of the external cylinder in parallel.

The acceleration part may accelerate the plasma by applying a driving frequency to the at least one second external and internal coils in sequence and sequentially generating gradients of magnetic fields orthogonal to the axial direction in the channel.

A first driving frequency that is a driving frequency of the at least one first external and internal coils may be different from a second driving frequency that is a driving frequency of the at least one second external and internal coils.

The first driving frequency may be higher than the second driving frequency. The first driving frequency may be a maximum value obtained by multiplying the plasma generation efficiency and the plasma acceleration efficiency according to the first driving frequency.

The first driving frequency may be selected from a range between 0.5 MHz and 5 MHz.

The first driving frequency may be a maximum value obtained by multiplying the plasma generation efficiency and the plasma acceleration efficiency according to the first driving frequency and dividing the multiplication by an intensity of a driving frequency according to the first driving frequency.

The first driving frequency may be 2 MHz.

The nozzle part may include at least one third external and internal coils wound along the inner wall of the internal cylinder and the outer wall of the external cylinder in parallel with the at least one second external and internal coils for creating magnetic fields in the axial direction.

The at least one third external and internal coils may be driven by currents flowing in opposite directions.

A neutral beam dry etching apparatus can perform the dry-etching on a wafer to fabricate a semiconductor chip using the electromagnetic accelerator according to exemplary embodiments of the present invention.

In accordance with another aspect of the present invention, an electromagnetic accelerator includes external and internal cylinders located on a same axis with different diameters from each other, an initial discharge part for generating a plasma in a channel that is defined between the external and internal cylinders by creating a magnetic field in a direction orthogonal to the axial direction, and an acceleration part disposed on the external and internal cylinders for accelerating the plasma in the axial direction. A composite wave, which is synthesized from a frequency of a current applied to the initial discharge part and a frequency of a current applied to the acceleration part, is applied to the initial discharge part and the acceleration part, respectively.

The electromagnetic accelerator may further include a nozzle part for compressing the plasma from the acceleration part and uniformly emitting the compressed plasma by creating a magnetic field in the axial direction.

The frequency of the current applied to the acceleration part may satisfy the following equation:

$$f ( N ) = \frac{{V}_{Z}}{( N - 1 ) d}$$

where ƒ is the frequency of the current applied to the acceleration part, V_{Z} is an ion velocity of the plasma, N is a number of coils, and d is a distance between the coils.

The frequency of the current applied to the initial discharge part may be selected from a range between 0.5 MHz and 5 MHz.

The frequency of the current applied to the initial discharge part may be 2 MHz.

### BRIEF DESCRIPTION OF THE DRAWING FIGURES

These and other aspects and advantages of the invention will become apparent and more readily appreciated from the following description of exemplary embodiments, taken in conjunction with the accompanying drawing figures of which:

FIG. 1 is a cut-away perspective view of a conventional electromagnetic accelerator;

FIG. 2 is a graph showing distribution of magnetic fields generated in a channel of the electromagnetic accelerator of FIG. 1;

FIG. 3 is a perspective view of an electromagnetic accelerator having a nozzle part according to an exemplary embodiment of the present invention;

FIG. 4A is a graph showing efficiency of a plasma acceleration depending on a driving frequency;

FIG. 4B is a graph showing efficiency of a plasma generation depending on the driving frequency;

FIG. 4C is a graph showing efficiency of the electromagnetic accelerator depending on the driving frequency;

FIG. 4D is a graph showing a amplitude of a driving current depending on the driving frequency;

FIG. 5 is a cross sectional view of the electromagnetic accelerator having the nozzle part according to an exemplary embodiment of the present invention;

FIG. 6 is a conceptual diagram showing a simulation result of obtaining a frequency having a maximum ion velocity in three-dimensions under conditions that a z-axis direction energy Wᵢ₀ of an initial ion is 40 eV and a distance between coils of the electromagnetic accelerator is 1.5 cm;

FIG. 7A is a graph showing an optimal frequency depending on a number of coils;

FIG. 7B is a graph showing the ion velocity gain depending on the number of coils; and

FIG. 8 is a waveform diagram of a current applied to the electromagnetic accelerator according to an exemplary embodiment of the present invention.

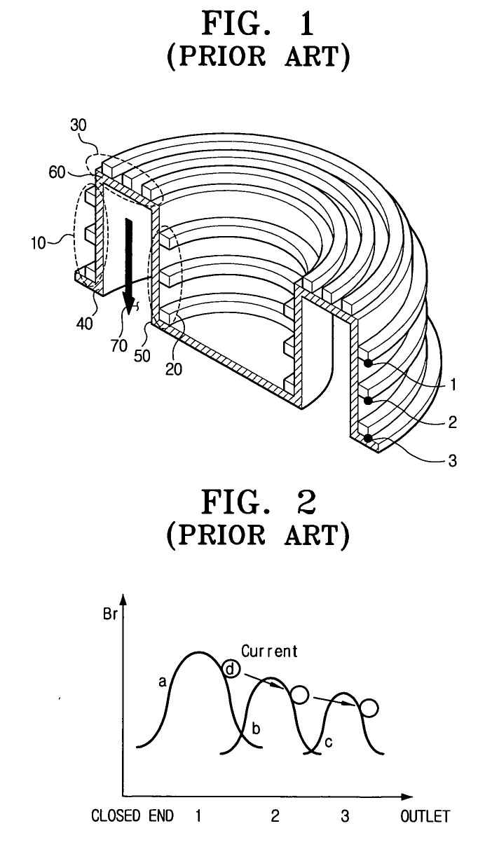

### DETAILED DESCRIPTION OF EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

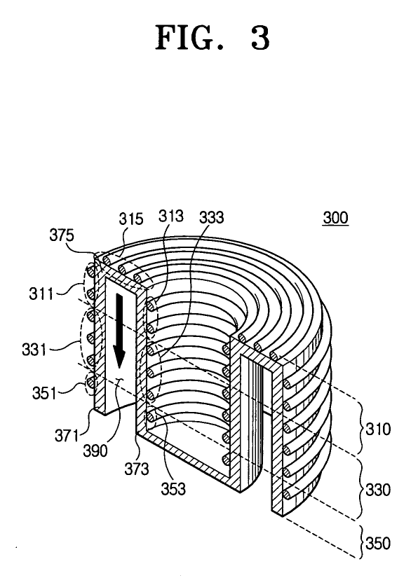

FIG. 3 is a perspective view of an electromagnetic accelerator having a nozzle part according to an exemplary embodiment of the present invention.

The electromagnetic accelerator 300 according to an exemplary embodiment of the present invention accelerates a plasma to high energy. Preferably, the electromagnetic accelerator 300 is applicable to a neutral beam dry etching apparatus of a wafer in the semiconductor fabrication process.

The electromagnetic accelerator 300 is divided into three functional sections for the sake of uniformity of the plasma generation, the plasma acceleration, and the plasma flow, and the three functional sections are controlled to operate by different frequencies.

Referring to FIG. 3, the electromagnetic accelerator 300 includes an external cylinder 371, an internal cylinder 373, a connection part 375, an initial discharge part 310, an acceleration part 330 and a nozzle 350. The components of the electromagnetic accelerator 300 operate by power having different frequencies and carry out different functions.

The construction of the electromagnetic accelerator 300 is first explained as a whole to facilitate the understanding of the initial discharge part 310, the acceleration part 330, and the nozzle part 350.

The initial discharge part 310, the acceleration part 330, and the nozzle 350 each include first through third external coils 311, 331, and 351, first through third internal coil 313, 333, and 353, and a discharge coil 315, respectively.

The external cylinder 371 and the internal cylinder 373 are formed side by side along cylindrical walls that have the same axis. The external cylinder 371 and the internal cylinder 373 are connected by the connection part 375 to define a channel 390. It is noted that a diameter of the internal cylinder 373 is smaller than that of the external cylinder 371. Advantageously, the external cylinder 371, the internal cylinder 373, and the connection 375 are formed with dielectric substances.

The channel 390 is a space where the plasma is generated and flows, and the plasma is accelerated in a direction from a closed end to an open end (hereinafter, referred to as an outlet) of the channel 390 as indicated by an arrow. Accordingly, the outlet of the channel 390 faces a wafer (not shown).

The first through third external coils 311, 331, and 351 each include at least one coil, and wind an outer wall of the external cylinder 371 along virtual circumferences that are on different orthogonal planes traversing a central axis, based on the central axis with a diameter greater than that of the external cylinder 371. At least one coil wound in parallel at the initial discharge part 310 is the first external coil 311, at least one coil wound in parallel at the acceleration part 330 is the second external coil 331, and at least one coil wound in parallel at the nozzle part 350 is the third external coil 351.

The first through third internal coils 313, 333, and 353 each include at least one coil, and wind an inner wall of the internal cylinder 373 along virtual circumferences that are on different orthogonal planes traversing the central axis, with a diameter smaller than that of the internal cylinder 373 based on the central axis. At least one coil wound in parallel at the initial discharge part 310 is the first internal coil 313, at least one coil wound in parallel at the acceleration part 330 is the second internal coil 333, and the at least one coil wound in parallel at the nozzle part 350 is the third internal coil 353.

The discharge coil 315 includes at least one coil, and winds based on the central axis an upper surface of the connection part 375 along at least one virtual circumference that is on the same orthogonal plane traversing the central axis with a diameter greater than the internal cylinder 373 and smaller than the external cylinder 371. The coils of the discharge coil 315 have different diameters from each other. The coils of the discharge coil 315 may be respective concentric circles, or a single coil wound along the concentric coil. The discharge coil 315 belongs to the initial discharge part 310.

It is preferred that the power with different frequencies is applied to the first through third external coils 311, 331, and 351, the first through third internal coils 313, 333, and 353, and the discharge coil 315 by a separate driving power source at each winding.

The following explains the initial discharge part 310, the acceleration part 330, and the nozzle part 350 based on the construction of the electromagnetic accelerator 300 as mentioned above.

The initial discharge part 310, the acceleration part 330, and the nozzle 350 share the external cylinder 371 and the internal cylinder 373, dividing and utilizing the channel 390.

The initial discharge part 310 includes the discharge coil 315, the first external coil 311, and the first internal coil 313. The initial discharge part 310 is responsible for generating the plasma in the channel 390.

The initial discharge part 310 uses a higher frequency than the frequencies of the power supplied to the acceleration part 330 and the nozzle part 350, to generate the plasma. The initial discharge part 310 can adopt the phase matching method or the driving frequency modulation method.

In case that the acceleration part 330 adopts the phase matching method, if the velocity of the plasma, which is generated at the initial discharge part 310 and enters the acceleration part 330, is too low, it is difficult to fulfill the phase matching method because of a too large phase difference. Hence, the initial discharge part 310 needs to generate and accelerate the plasma at an early stage substantially at the same time. A low driving frequency is advantageous for the acceleration, but depreciates the efficiency of the plasma generation because the energy transfer from the coil to the plasma is impeded. In this sense, the appropriate selection of the driving frequency is crucial for the generation and the initial acceleration of the plasma, to be explained below.

The acceleration part 330 includes the second external coil 331 and the second internal coil 333. The acceleration part 330 accelerates the plasma that is generated in the channel 390 to flow toward the outlet. To accelerate the generated plasma toward the outlet, the acceleration part 330 produces a gradient of the magnetic field according to the magnetic field modulation method or creates magnetic field pulses in sequence toward the outlet according to the phase matching method and the driving frequency modulation method.

The nozzle part 350 includes the third external coil 351 and the third internal coil 353. The nozzle part 350 compresses the plasma by creating the magnetic field at the outlet of the channel 390 in the axial direction so that the plasma passing through the nozzle part 350 can uniformly disperse upon escaping the electromagnetic accelerator 300.

Alternatively, if both the initial discharge part 310 and the acceleration part 330 adopt the phase matching method, the initial discharge part 310 and the acceleration part 330 can be combined without separation. In this situation, the power source having a single driving frequency can be used to thus simplify a control circuitry (not shown) of the electromagnetic accelerator 300.

Hereafter, the driving frequencies of the initial discharge part 310 and the acceleration part 330 are set forth.

The acceleration of the plasma conforms to Lorentz's force. The plasma needs ion energy as high as possible to get high ion energy. The Lorentz's force excels experimentally and theoretically in light of low frequency and low magnetic field pressure.

However, the low frequency depreciates the efficiency in the plasma generation, which implies the low efficiency of the energy transfer. Thus, when the acceleration part 330 adopts the phase matching method, the initial discharge part 310 should select the driving frequency in consideration of both the generation and the initial acceleration of the plasma.

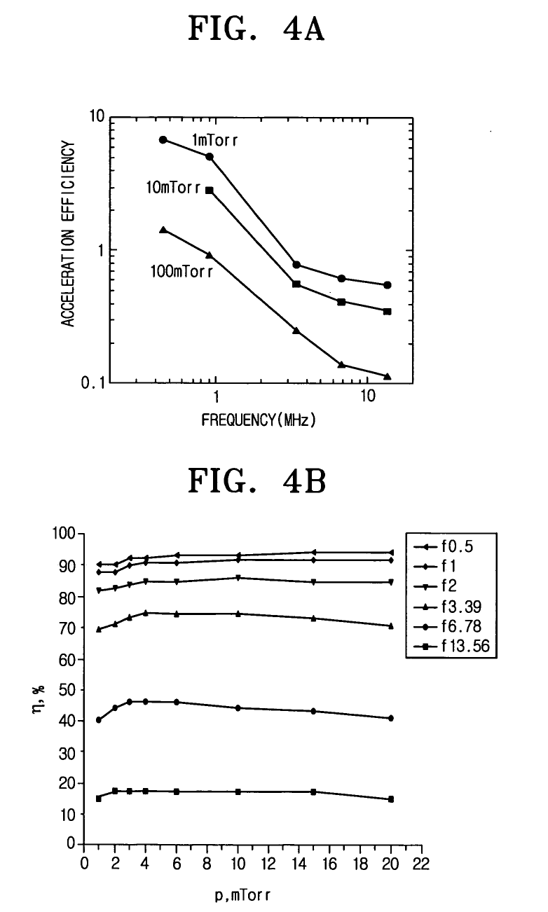

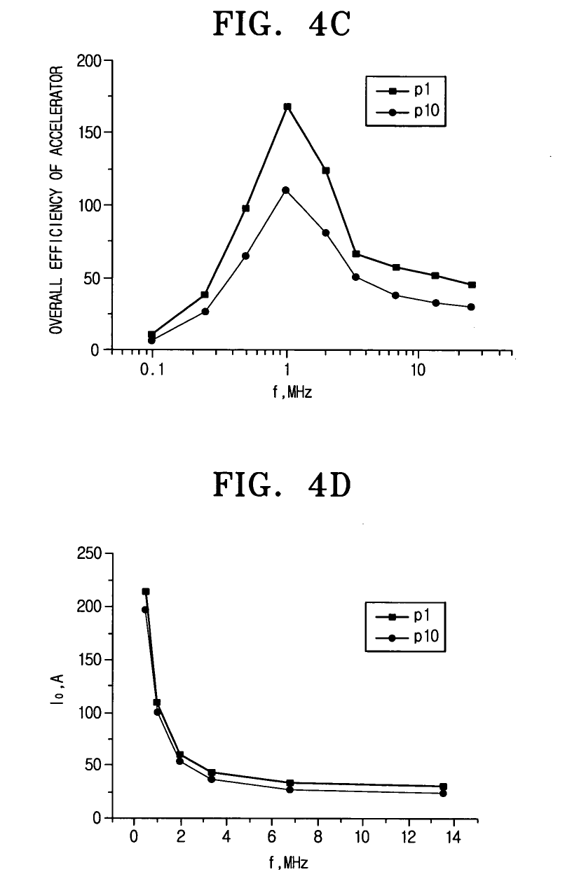

The selection of the suitable driving frequencies for the initial discharge part 310 and the acceleration part 330 is described in reference to FIG. 4A through FIG. 4D.

Graphs of FIG. 4A through FIG. 4D are obtained by using only the external cylinder, separately from the electromagnetic accelerator 300, and winding a single coil three times to get the high plasma generation and the acceleration efficiency of the plasma according to the driving frequencies. The graphs are based on a value measured at a location away from the uppermost part of the channel 390 by 1 cm within a radius of 4 cm based on the central axis when a pressure in the channel is 1, 10, and 100 mTorr, respectively.

Numerical results show a typical relationship between the generation and acceleration efficiency of the plasma and the driving frequency. The electromagnetic accelerator 300 determines the driving frequency based on the results to be explained in reference to FIG. 4A through FIG. 4D. This is because the mechanism for generating and accelerating the plasma depending on the driving frequency falls within the scope of the experiments as shown in FIG. 4A through FIG. 4D and the electromagnetic accelerator 300 according to an exemplary embodiment of the present invention.

FIG. 4A is a graph showing the acceleration efficiency of the plasma depending on the driving frequency.

In the graph of FIG. 4A, a horizontal axis indicates the driving frequency as a log scale, and a vertical axis indicates the acceleration efficiency as a ratio of Lorentz's force to the azimuthal electric field force.

Referring now to FIG. 4A, the lower the driving frequency and the pressure, the better the acceleration efficiency of the plasma. Hence, it is preferred that the pressure in the channel 390 is below 1 mTorr and the frequency is below 0.5 MHz for the acceleration part 330 of FIG. 3.

FIG. 4B is a graph showing the plasma generation efficiency depending on the driving frequency.

In the graph of FIG. 4B, a horizontal axis indicates the pressure in the channel 390 by mTorr, and a vertical axis indicates the energy transfer efficiency η by percentage. The calculation of FIG. 4B is conducted under the same conditions as in FIG. 4A. In FIG. 4B, the graph shows the results by the driving frequencies that are provided in the legend on the right side of the graph. In the legend, f0.5 denotes the driving frequency of 0.5 MHz, and f1 denotes the driving frequency of 1 MHz.

Referring to FIG. 4B, it can be seen that the higher the driving frequency, the better the plasma generation efficiency. Hence, it is preferred that the initial discharge part 310 of FIG. 3 use the frequency of at least 13.56 MHz under the pressure of 10 mTorr to obtain the optimal efficiency of the plasma generation.

The overall efficiency of the electromagnetic accelerator 300 is the multiplication of the plasma generation efficiency and the plasma acceleration efficiency as shown in FIG. 4C.

FIG. 4C is a graph showing the efficiency of the electromagnetic accelerator depending on the driving frequency.

In the graph of FIG. 4C, a horizontal axis indicates the driving frequency as the log scale, and a vertical axis indicates the efficiency of the electromagnetic accelerator 300 that is acquired by multiplying the results of FIG. 4A and FIG. 4B. In the legend, p1 denotes the pressure in the channel 390 is 1 mTorr, and p10 denotes that the pressure in the channel 390 is 10 mTorr.

As shown in FIG. 4C, the electromagnetic accelerator 300 shows the highest performance when the driving frequency is about 1 MHz. Note that the driving frequency of 1 MHz may be inappropriate in consideration of the product design since the electromagnetic accelerator 300 has too high of an intensity of the driving current as illustrated in FIG. 4D.

FIG. 4D is a graph showing the intensity of the driving current depending on the driving frequency.

The graph of FIG. 4D is calculated under the same conditions as the results shown in FIG. 4A and FIG. 4B and shows the intensity of the driving current to supply the power of 800 Watts into the channel 390. A horizontal axis indicates the driving frequency as the linear scale, and the vertical axis indicates the intensity of the driving current by the driving frequencies in units of amperes (A). In the legend, p1 denotes the pressure in the channel 390 is 1 mTorr, and p10 denotes the pressure in the channel 390 is 10 mTorr.

The driving current flowing through the coils of the electromagnetic accelerator 300 varies according to the impedance of the coils depending on the driving frequencies. Referring back to FIG. 4D, the driving current exceeds 100 A when the driving frequency is below 1 MHz.

Having the driving current be substantially more than 100 A is inappropriate at the design phase of the electromagnetic accelerator 300. A power unit (not shown) for supplying such a high current increases in size proportionally.

Therefore, an optimal driving frequency can be acquired by dividing the overall efficiency according to the driving frequencies as shown in FIG. 4C, by the driving current at the frequencies as shown in FIG. 4D. As a result, the driving frequency of 2 MHz under the pressure 3 mTorr in the channel 390 is the optimal frequency to maximize the efficiency of the electromagnetic accelerator 300.

As for the acceleration part 330, the driving frequency of about 2 MHz under the pressure 3 mTorr in the channel 390 is preferable, contrary to the experimental results as shown in FIG. 4A.

In the case of the phase matching method using only one driving frequency, it is preferred that the initial discharge part 310 drives with the driving frequency of about 2 MHz under the pressure 3 mTorr in the channel 390 for the generation and the initial acceleration of the plasma.

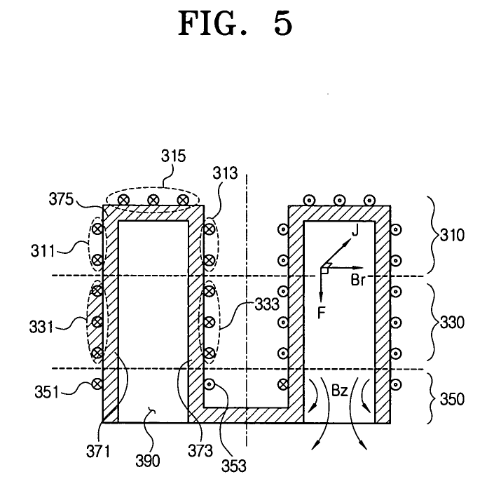

The following is an explanation of an operation of the electromagnetic accelerator having the nozzle part in reference to FIG. 5.

FIG. 5 is a cross sectional view of the electromagnetic accelerator having the nozzle part according to an exemplary embodiment of the present invention.

The same reference numbers as in FIG. 3 are given to the like elements in FIG. 5.

In FIG. 5, the coil is represented as a circle, and a dot or a letter ‘x’ in the circle ⊙ or \textcircled{x} represents the direction of the current flowing through the coil. In particular, the dot in the circle ⊙ implies the current flowing from the ground, and the letter ‘x’ in the circle \textcircled{x} implies the current flowing into the ground. It can be seen that the current passes through the coils in the clockwise direction based on the central axis of the external and internal cylinders 371 and 373 from the point of view at the closed end toward the outlet. It is noted that the current flowing through the coils, which is an alternating current with a certain frequency, will reverse its direction at regular intervals.

The initial discharge part 310 generates the plasma.

When the current flows through the discharge coil 315, the first external coil 311, and the first internal coil 313, the magnetic fields are generated around the discharge coil 315, the first external coil 311, and the first internal coil 313 according to Ampere's law. The magnetic fields generated in the channel 390 by the discharge coil 315, the first external coil 311, and the first internal coil 313, may be damped or intensified due to another magnetic field generated by other coils. In detail, the magnetic fields generated in the axial direction, which are opposite to each other, are damped, and the magnetic field Br traversing the channel 390 is intensified.

The magnetic field Br in the channel 390 induces the secondary current J according to the Maxwell's equations. In FIG. 5, it is illustrated that the secondary current J is induced in the opposite direction to the current flowing through the first external and internal coils 311 and 313 by the magnetic field Br that traverses the channel 390.

An electromagnetic force F accelerating the plasma from the closed end toward the outlet is generated by the induced second current J and the magnetic field Br traversing the channel 390 based on Equation 1.
\vec{F}=\vec{J}×\vec{B} [Equation 1]

The plasma exhibits collective behavior because of the long range nature of the Coulomb force, and drifts toward the outlet owing to the electromagnetic force F. In other words, as the magnetic pressure at the closed end is high and the magnetic pressure at the outlet is low, the plasma drifts from the closed end toward the outlet of the channel 390.

The acceleration part 330 accelerates the plasma generated at the initial discharge part 310 toward the outlet. The plasma acceleration toward the outlet at the acceleration part 330 is similar to the plasma drift at the initial discharge part 310. A difference lies in that the acceleration part 330 is regulated for the sake of the plasma acceleration.

To accelerate the plasma, a current with the same frequency is applied to the second external and internal coils 331 and 333 in sequence and the sequential gradients of the second magnetic fields are generated. In this case, magnetic pulses are created in the channel 390 by regulating the phase of the gradients of the second magnetic field, or, by applying different frequencies to the second external and internal coils 331 and 333, respectively, and applying the current with a lower frequency as it advances toward the outlet. Alternatively, the plasma may be accelerated through the gradients of the magnetic field pressures by lowering the current intensity at the second external and internal coils 331 and 333 as advancing toward the outlet.

The nozzle part 350 reverses the direction of the current flowing through the third external and internal coils 351 and 353, and thus generates a strong magnetic field Bz in the axial direction in the channel 390. The magnetic field Bz is not damped but is intensified in the axial direction, which is different from the magnetic field Br generated at the initial discharge part 310 and the acceleration part 330. The magnetic field Bz in the axial direction compresses the plasma that has passed through the acceleration part 330. Thus, the compressed plasma passing through the nozzle part 350 is uniformly emitted in widespread fashion upon escaping the outlet of the electromagnetic accelerator 300.

A dry etching apparatus employing the electromagnetic accelerator according to an exemplary embodiment of the present invention can uniformly diffuse the plasma all over the wafer to be etched. Such a dry etching apparatus is more effective in etching more than one wafer at a time.

As described above, the electromagnetic accelerator having the nozzle part can generate and accelerate the plasma.

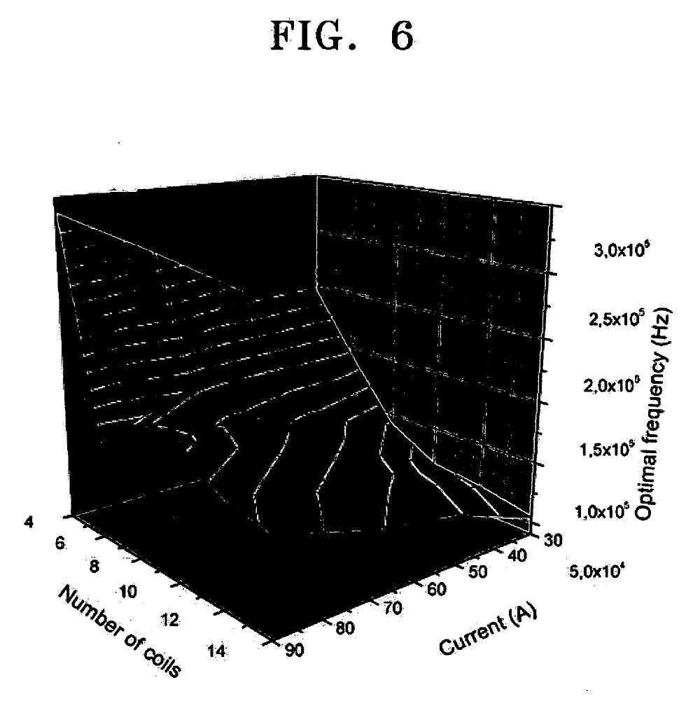

FIG. 6 is a conceptual diagram showing, in a three-dimensional space, a simulation result of discovering a frequency with a maximum ion velocity under conditions that a z-axis direction energy Wᵢ₀ of an initial ion is 40 eV and a distance d between the coils of the electromagnetic accelerator is 1.5 cm. The simulation employs the finite difference method (FDM) and the particle simulation that are well-known numerical analysis solutions and not explained in detail for brevity.

Table 1 shows the simulation result of FIG. 6 to facilitate the analysis.

TABLE 1

| j/N | 4 | 6 | 8 | 10 | 12 | 14 |
|---|---|---|---|---|---|---|
| 30 A | 1.95 | 1.40 | 0.9 | 0.68 | 0.63 | 0.54 |
| 50 A | 2.07 | 1.41 | 1.14 | 1.00 | 0.89 | 0.81 |
| 70 A | 2.50 | 1.47 | 1.27 | 1.19 | 1.04 | 0.94 |
| 90 A | 2.90 | 1.17 | 1.47 | 1.50 | 1.24 | 1.16 |

In Table 1, the row N indicates the number of coils, and the column j indicates the intensity of the current. The unit of the frequency is 10⁵ Hz.

As shown in Table 1, as for the high current of 90 A, the ion velocity is maximized when the number of coils is 10 and the optimal frequency becomes 0.15 MHz. The ion velocity can be regarded as the plasma velocity since the plasma consists of electrons and positively charged ions. Referring back to FIG. 4C and FIG. 4D, the plasma generation and acceleration exhibit the maximum capability as for the frequency of 2 MHz. However, as to 2 MHz, the plasma acceleration is interrupted by the magnetic field applied before the plasma passes through the coil because the phase velocity of the magnetic field B is greater than the plasma velocity. To prevent this, the distance between the coils needs to be shortened but suffers the limitation in the semiconductor fabrication process. Thus, the frequency of 2 MHz is not applicable.

To predict the velocity of the ion particles using computations, the equation of motion and Maxwell's equations are utilized. Provided that the driving frequency, the distance between the coils, and the current flowing through the coil are given, solutions for the equations are obtained using the finite difference method (FDM) and the particle simulation, and the most suitable driving condition is attained from the solutions as shown in Table 2 and Table 3.

Table 2 shows the conditions necessary to acquire the outlet energy 500 eV of the ions.

TABLE 2

| Gas density | 2 E13 | cm-3 |
|---|---|---|
| ICP current | 70 | A |
| ICP frequency | 2 | MHz |
| Number of TWP coils | 14 | |
| TWP current | 90 | A |
| TWP frequency | 0.116 | MHz |

Table 3 shows the conditions necessary to acquire the outlet energy 100 eV of the ions.

TABLE 3

| Gas density | 2 E13 | cm-3 |
|---|---|---|
| ICP current | 70 | A |
| ICP frequency | 2 | MHz |
| Number of TWP coils | 8 | |
| TWP current | 50 | A |
| TWP frequency | 0.114 | MHz |

In Tables 2 and 3, the gas density represents the gas density within the electromagnetic accelerator. The Inductively Coupled Plasma (ICP) current is the current at the initial discharge part 310, and the ICP frequency is the frequency of the ICP current. The Traveling Wave Plasma (TWP) current is the current at the acceleration part 330, and the TWP frequency is the frequency of the TWP current.

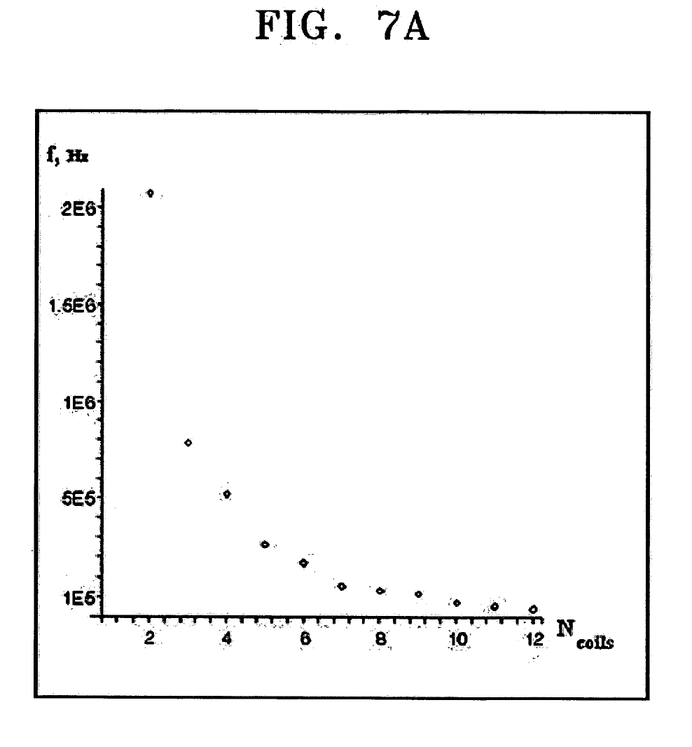

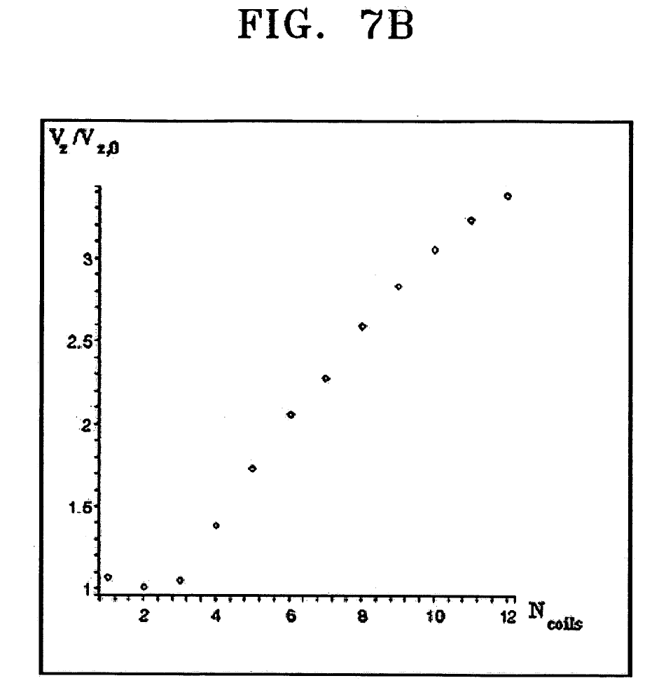

FIG. 7A is a graph showing the optimal frequency depending on the number of coils, and FIG. 7B is graph showing the ion velocity gain depending on the coil order. Herein, it is assumed that there is no friction among the ions, and that the z-axis direction energy Wᵢ₀ of the initial ion is 10 eV.

In FIG. 7A, the FDM and the particle simulation are adopted to obtain the optimal frequency that satisfies the maximum ion velocity for each number of coils. In FIG. 7B, the ion velocity is computed corresponding to the optimal frequency of FIG. 7A. It can be seen that the optimal frequency ƒ and the ion velocity V_{Z} satisfy Equation 2.
[Equation 2]

$$f ( N ) = \frac{{V}_{Z}}{( N - 1 ) d} \qquad [ Equation 2 ]$$

In Equation 2, ƒ is the optimal frequency, V_{Z} is the ion velocity, N is the number of coils, and d is the distance between the coils.

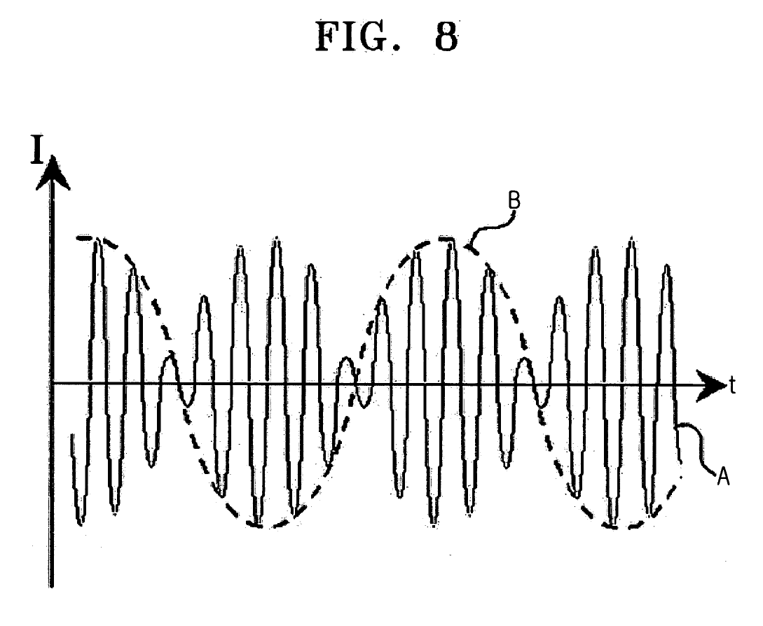

FIG. 8 is a waveform diagram of a current applied to the electromagnetic accelerator according to an exemplary embodiment of the present invention. A horizontal axis indicates a time t, and a vertical axis indicates an amplitude I of the current. ‘A’ indicates plasma generation pulses applied to the initial discharge part 310, and ‘B’ indicates plasma acceleration pulses applied to the acceleration part 330. According to Table 2, the frequency of the pulses A is 2 MHz, and the frequency of the pulses B is 0.116 MHz. The frequency 2 MHz and the frequency 0.116 MHz are synthesized by a frequency synthesizer, and thus a waveform is produced as shown in FIG. 8. The frequency of the pulses A is 2 MHz, the frequency of the pulses B is a frequency satisfying Equation 2. The plasma generation efficiency and the acceleration efficiency of the electromagnetic accelerator can be enhanced by applying one composite wave to the electromagnetic accelerator, without having to applying different frequencies to the initial discharge part 310 and the acceleration part 330, respectively.

Alternatively, the plasma generation efficiency and the plasma acceleration efficiency may be facilely enhanced by applying the current with only one composite wave to an electromagnetic accelerator having no nozzle part 350. It is true to Table 3, and thus its description is omitted for conciseness.

In light of the foregoing as set forth above, the present invention realizes the electromagnetic accelerator maximizing the plasma generation efficiency and the plasma acceleration efficiency.

The acceleration efficiency can be maximized without adversely affecting the plasma generation efficiency even when the electromagnetic accelerator is driven using only one driving frequency.

Furthermore, as the plasma is uniformly emitted on a surface from the electromagnetic accelerator, the uniformity of the plasma emission can be improved. Accordingly, an etching apparatus, which etches at least one wafer at one time, is able to uniformly etch the wafer regardless of the location of the wafer.

The composite wave, which is synthesized from the frequency for plasma generation and the frequency for plasma acceleration and applied with the current, aids to maximize the plasma generation efficiency and the plasma acceleration efficiency.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An electromagnetic accelerator comprising:
external and internal cylinders of different diameters located on a same axis;
an initial discharge part which generates a plasma in a channel that is defined between the external and internal cylinders by creating a magnetic field in a direction orthogonal to an axial direction;
an acceleration part which accelerates the plasma in the axial direction and is disposed on the external and internal cylinders; and
a nozzle part which compresses the plasma from the acceleration part and uniformly emits the compressed plasma by creating a magnetic field in the axial direction.

2. The electromagnetic accelerator of claim 1, wherein the initial discharge part comprises:
a connection part which connects the external and internal cylinders at an opposite side to the plasma acceleration and closes one end of the channel;
a discharge coil wound such that a diameter of the discharge coil decreases along an upper surface of the connection part; and
at least one first external coil and at least one first internal coil which create magnetic fields by winding along an inner wall of the internal cylinder and an outer wall of the external cylinder in parallel.

3. The electromagnetic accelerator of claim 1, wherein the acceleration part comprises:
at least one second external coil and at least one second internal coil which accelerate the plasma in the axial direction by winding along the inner wall of the internal cylinder and the outer wall of the external cylinder in parallel.

4. The electromagnetic accelerator of claim 1, wherein the initial discharge part comprises:
at least one first external coil and at least one first internal coil which create magnetic fields by winding in parallel along an inner wall of the internal cylinder and an outer wall of the external cylinder; and
at least one second external coil and at least one second internal coil which accelerates the plasma in the axial direction by winding in parallel with the at least one first external and internal coils along the inner wall of the internal cylinder and the outer wall of the external cylinder.

5. The electromagnetic accelerator of claim 4, further comprising:
a connection part which connects the external and internal cylinders at an opposite side to the plasma acceleration and closes one end of the channel; and
at least one discharge coil wound such that a diameter of the discharge coil decreases along an upper surface of the connection part.

6. The electromagnetic accelerator of claim 4, wherein the acceleration part accelerates the plasma by applying a driving frequency to the at least one second external coil and at least one second internal coil in sequence and sequentially generates gradients of magnetic fields orthogonal to the axial direction in the channel.

7. The electromagnetic accelerator of claim 4, wherein a first driving frequency that is a driving frequency of the at least one first external coil and at least one first internal coil is different from a second driving frequency that is a driving frequency of the at least one second external and internal coils.

8. The electromagnetic accelerator of claim 7, wherein the first driving frequency is higher than the second driving frequency.

9. The electromagnetic accelerator of claim 8, wherein the first driving frequency is a maximum value obtained by multiplying a generation efficiency of the plasma and an acceleration efficiency of the plasma according to the first driving frequency.

10. The electromagnetic accelerator of claim 9, wherein the first driving frequency is selected from a range between 0.5 MHz and 5 MHz.

11. The electromagnetic accelerator of claim 8, wherein the first driving frequency is a maximum value obtained by multiplying a generation efficiency of the plasma and an acceleration efficiency of the plasma according to the first driving frequency and dividing a multiplication result by an intensity of a driving current according to the first driving frequency.

12. The electromagnetic accelerator of claim 11, wherein the first driving frequency is 2 MHz.

13. The electromagnetic accelerator of claim 3, wherein the nozzle part comprises:
at least one third external coil and at least one third internal coil, wound along an inner wall of the internal cylinder and an outer wall of the external cylinder in parallel with the at least one second external and internal coils, which creates magnetic fields in the axial direction.

14. The electromagnetic accelerator of claim 13, wherein the at least one third external coil and at least one third internal coil are driven by currents flowing in opposite directions.

15. The electromagnetic accelerator of claim 4, wherein the nozzle part comprises:
at least one third external coil and at least one third internal coil, wound along an inner wall of the internal cylinder and an outer wall of the external cylinder in parallel with the at least one second external coil and at least one second internal coil, which creates magnetic fields in the axial direction.

16. A neutral beam dry etching apparatus for dry-etching a wafer to fabricate a semiconductor chip using an electromagnetic accelerator, the electromagnetic accelerator comprising:
external and internal cylinders of different diameters located on a same axis;
an initial discharge part which generates a plasma in a channel that is defined between the external and internal cylinders by creating a magnetic field in a direction orthogonal to an axial direction;
an acceleration part which accelerates the plasma in the axial direction and is disposed on the external and internal cylinders; and
a nozzle part which compresses the plasma from the acceleration part and uniformly emits the compressed plasma by creating a magnetic field in the axial direction.

17. An electromagnetic accelerator comprising:
external and internal cylinders of different diameters located on a same axis;
an initial discharge part which generates a plasma in a channel that is defined between the external and internal cylinders by creating a magnetic field in a direction orthogonal to an axial direction; and
an acceleration part which accelerates the plasma in the axial direction and is disposed on the external and internal cylinders, and
a composite wave, which is synthesized from a frequency of a current applied to the initial discharge part and a frequency of a current applied to the acceleration part, is applied to the initial discharge part and the acceleration part, respectively.

18. The electromagnetic accelerator of claim 17, further comprising:
a nozzle part which compresses the plasma from the acceleration part and uniformly emits the compressed plasma by creating a magnetic field in the axial direction.

19. The electromagnetic accelerator of claim 18, wherein the frequency of the current applied to the acceleration part satisfies the following equation:
$$f ( N ) = \frac{{V}_{Z}}{( N - 1 ) d}$$
where ƒ is the frequency of the current applied to the acceleration part, V_{Z} is an ion velocity of the plasma, N is a number of coils, and d is a distance between the coils.

20. The electromagnetic accelerator of claim 19, wherein the frequency of the current applied to the initial discharge part is selected from a range between 0.5 MHz and 5 MHz.

21. The electromagnetic accelerator of claim 20, wherein the frequency of the current applied to the initial discharge part is 2 MHz.
